(19) United States
(12) Patent Application Publication
(10) Pub. No.: US 2011/0304298 A1
(43) Pub. Date: Dec. 15, 2011

(54) BATTERY CHARGING USING MULTIPLE CHARGERS

(75) Inventors: Philippe Hart Gow, Santa Monica, CA (US); David Leslie Edwards, Newburgh, IN (US); Alex Hamade, Santa Monica, CA (US)

(73) Assignee: Coda Automotive, Inc., Los Angeles, CA (US)

(21) Appl. No.: 13/104,401

(22) Filed: May 10, 2011

Related U.S. Application Data
(60) Provisional application No. 61/334,337, filed on May 13, 2010.

(51) Int. Cl. H02J 7/00

(52) U.S. Cl. 320/107; 320/138

(57) ABSTRACT

Systems and methods providing improved battery charging using systems comprising multiple chargers are generally described. In some embodiments, the chargers can communicate with each other. In some embodiments, a battery management unit (BMU) can be used to communicate with at least one of the chargers, and, in some cases, all of the chargers. The system can be configured such that the charging load can be distributed among multiple chargers, or to a single charger, depending on the amount of charging power required at a given time. The system can also be configured to alternate which charger(s) handle the charging load over a period of time. For example, when only a single charger is needed to handle the total charging load, the system can be configured such that the load is handled by a first charger over a first period of time, a second charger of a second period of time, etc. The charging load distribution scheme can be based at least in part upon one or more commands transmitted between two chargers and/or between a charger and the BMU.

### RELATED APPLICATIONS

This application claims priority under 35 U.S.C. §119(e) to U.S. Provisional Patent Application No. 61/334,337, filed May 13, 2010, and entitled “Battery Charging Using Multiple Chargers,” which is incorporated herein by reference in its entirety for all purposes.

### FIELD

Systems and methods providing improved battery charging using multiple chargers are generally described.

### BACKGROUND

Battery packs comprising rechargeable battery cells (also known as secondary cells) can be used to power a wide range of devices, including electronic vehicles. Generally, once the energy in a rechargeable battery pack has been expended, the cells are recharged via a charger connected to an alternating current (AC) source. Many traditional battery pack charging systems employ single chargers designed to handle the entire charging load of the battery pack at a set power rating. Such systems can be disadvantageous for several reasons. For example, when the charger fails in a single-charger system, no backup chargers are available to assume the charging load. In addition, single-charger units can be inflexible, providing a fixed power output when more or less power may be required for a given application.

Accordingly, improved systems and methods are needed.

### SUMMARY

Systems and methods to improve battery charging using multiple chargers are provided.

In one set of embodiments, a method of charging a battery is described. The method can comprise, in some cases, providing a charging system comprising a first charger, a second charger, and a battery management unit; and initializing the first and second chargers to determine which of the first and second chargers will subsequently allocate the charging load between the first and second chargers.

In some embodiments, the method can comprise providing a first charger, providing a second charger, charging the battery over a first period of time wherein substantially none of the charging power is provided by the second charger, and charging the battery over a second period of time wherein substantially none of the charging power is provided by the first charger.

The method can comprise, in some instances, providing a charging system comprising a plurality of chargers and a battery management unit wherein each of the plurality of chargers is constructed and arranged to provide power up to a threshold power amount; and allocating a requested charging power amount among the plurality of chargers wherein, if the requested charging power is less than the maximum of the threshold power amounts of the plurality of chargers, one of the plurality of chargers provides the entire amount of requested charging power, and wherein, if the requested charging power is more than the maximum of the threshold power amounts of the plurality of chargers, the requested charging power is provided by at least two of the plurality of chargers.

In one set of embodiments, a system for charging a battery is provided. The system can comprise, in some cases, a first charger and a second charger, wherein at least one of the first and second chargers is constructed and arranged to allocate the charging load between the first and second chargers.

In some instances, the system can comprise a first charger and a second charger, wherein the system is constructed and arranged such that the first charger provides the entire system charging power over a first period of time, and the second charger provides the entire system charging power over a second period of time that does not overlap with the first period of time.

Other advantages and novel features will become apparent from the following detailed description of various non-limiting embodiments when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the embodiments described herein. In the figures:

FIG. 1 includes a schematic illustration of a battery charging system, according to one set of embodiments;

FIG. 2 includes, according to some embodiments, a schematic illustration of a charger; and

FIG. 3 includes an exemplary schematic illustration of a battery charging system comprising a CAN-bus.

### DETAILED DESCRIPTION

Systems and methods providing improved battery charging using systems comprising multiple chargers are generally described. In some embodiments, the chargers can communicate with each other. A battery management unit (BMU) can be used to communicate with at least one of the chargers, and, in some cases, all of the chargers. The system can be configured such that the charging load can be distributed among multiple chargers or to a single charger, depending on the amount of charging power required at a given time. The system can also be configured to alternate which charger(s) handle the charging load over a period of time. For example, when only a single charger is needed to handle the total charging load, the system can be configured such that the load is handled by a first charger over a first period of time, a second charger of a second period of time, etc. The charging load distribution scheme can be based at least in part upon one or more commands transmitted between two chargers and/or between a charger and the BMU.

The inventors have discovered that the use of a charging system comprising more than one charger can provide one or more of the following advantages. In some embodiments, the overall life span of the charging system can be increased relative to a charging system with a single charger. The ability to distribute the charging load among multiple chargers or through a single charger can also allow one to control the total charging power of the charging system at a given time, allowing for fast or slow charging rates. In addition, the use of multiple chargers can provide a backup charging pathway in case one or more of the chargers fails to operate properly. In many applications, packaging multiple relatively small chargers (e.g., two 3.3 kW chargers) can be more convenient than packaging a single relatively large charger (e.g., one 6.6 kW charger). For example, the ability of relatively small chargers to fit into relatively small volumes permits storage in multiple low-profile locations.

The systems and methods described herein can be used to charge batteries in a wide variety of systems such as, for example, portable electronic devices, stationary energy generation systems (e.g., utility power storage and the like), and the like. Some embodiments can be particularly useful for charging a battery in a passenger vehicle, such as a battery pack used to power the drive train of an electric vehicle.

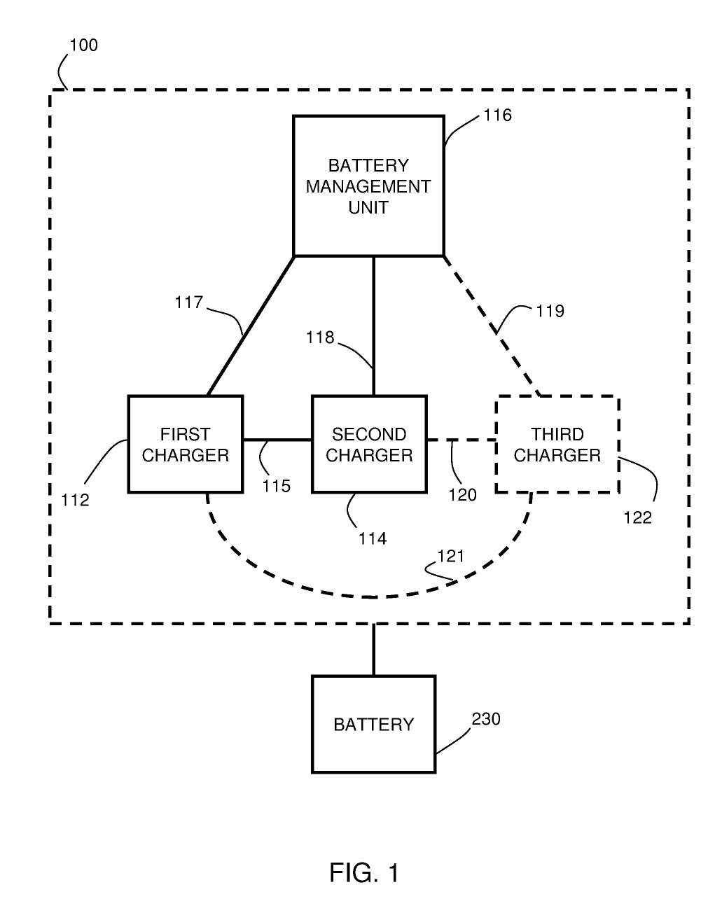

FIG. 1 shows a charging system 100 comprising multiple chargers, according to one set of embodiments, for charging battery 230. Charging system 100 includes first charger 112 and second charger 114. Any suitable type of chargers can be used in accordance with the embodiments described herein. Generally, each charger will be selected such that it is capable of applying a voltage to the cells of the battery pack that is higher than the electromotive force of the cells, thereby recharging the cells. Types of chargers that can be used include, but are not limited to, simple chargers (i.e., chargers that apply a constant DC power to the cell being charged), fast chargers, and the like. Each of the chargers within the charging system can be rated, in some cases, to provide a substantially identical maximum charging power (e.g., multiple 3.3 kW chargers). In some embodiments, the hardware and/or software within each of the chargers in the charging system can be substantially identical.

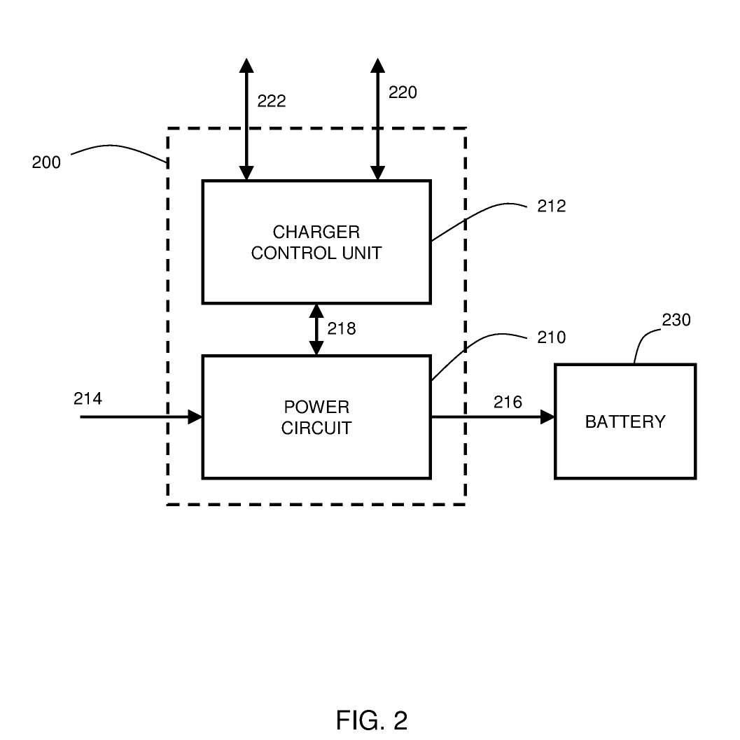

FIG. 2 includes a schematic diagram of an exemplary charger that can be used in accordance with the systems and methods described herein. In FIG. 2, charger 200 includes power circuit 210 and charger control unit 212. The power circuit can be used to convert incoming AC power (e.g., via electrical connection 214) to DC power suitable for charging a battery (e.g., battery 230 via electrical connection 216). One of ordinary skill in the art would be capable of identifying a suitable power circuit for use in a given charging application. Charger control unit 212 can be constructed and arranged to control the amount of power provided by the power circuit, for example, by communicating with the power circuit via link 218. The charger control unit can also be constructed and arranged to communicate with the charger control units of other chargers (e.g., via link 220) and/or a battery management unit (e.g., via link 222), which is described in more detail below.

Referring back to FIG. 1, a communication link can be used to transfer data between the first and second chargers, each of which can be capable of transmitting and/or receiving data. For example, as illustrated in FIG. 1, first charger 112 can communicate with second charger 114 via communication link 115.

In some embodiments, the charging system can also include a battery management unit (BMU) which can transmit data to and/or receive data from one or more of the chargers within the charging system. For example, in FIG. 1, charging system 100 includes BMU 116, with communication links 117 and 118 allowing for data transfer between the BMU and first charger 112 and second charger 114, respectively.

Communication between the BMU and a charger and/or between the chargers can be facilitated, in some instances, by designating one of the chargers the primary charger and the other chargers as secondary chargers. In some cases, the primary/secondary designation for each charger can be assigned during an initialization sequence. In the set of embodiments illustrated in FIG. 1, for example, each of chargers 112 and 114 can comprise an input (e.g., a digital or analog input) constructed and arranged to receive a signal indicating whether the charger should be the primary charger or the secondary charger.

The BMU can include, in some instances, a primary link and one or more secondary links. The primary link can include a feature that differentiates it from the secondary link(s). For example, when a harness cable is used to establish communication between the BMU and a charger, the primary cable can include a pull up on one input pin of the charger. Because this feature is present in the connection cable, rather than the charger itself, the primary and secondary charger(s) can have identical hardware and/or software, and can be interchangeable, while maintaining the ability to serve as both a primary and secondary charger. In the set of embodiments illustrated in FIG. 1, link 117 can be set as the primary link and link 118 can be set as the secondary link.

The charger associated with the primary link (e.g., charger 112 in FIG. 1) can be designated as the default primary charger. Upon receiving a signal from the BMU and transmitting a confirmation signal back to the BMU, the default primary charger can assume the role of primary charger, and, in some cases, configure its programming accordingly (e.g., adopting a “primary node” message set). Once the default primary charger is assigned as the primary charger, each additional charger in the system can receive a signal (e.g., via the BMU or directly from the primary charger) indicating that the primary charger has been assigned and is functioning properly (i.e., is able to charge), after which, each of the additional chargers can be assigned as secondary chargers. In the set of embodiments illustrated in FIG. 1, primary link 117 (e.g., a wired connection) can be constructed and arranged to include a relatively high logic level, while secondary link 118 (e.g., a second wired connection) can be constructed and arranged to include a relatively low logic level. Assuming normal function, charger 112, by virtue of being connected to the BMU via primary link 117, can assume the role of the primary charger and, in some cases, configure its programming to use a “primary node” message set. In such cases, charger 114 can assume the role of secondary charger and, in some cases, configure its programming to use a “secondary node” message set.

Assigning the roles of primary charger and secondary charger using an initialization sequence, as described above, can provide a great deal of flexibility when one or more chargers in the system fails. If the default primary charger is not functioning properly but is still able to communicate with the BMU and/or the other chargers in the system, the default primary charger can send a signal (to the BMU and/or directly to the other chargers) indicating that it is unavailable for charging, and that another charger should be assigned the role of primary charger. Once it has been determined that the default primary charger is unavailable and a secondary charger is available to assume the role of the primary charger, the newly assigned primary charger can handle the charging load of the system, either individually (up to its operating limits) or by distribution of the load among itself and/or other chargers in the system.

For example, in FIG. 1, if charger 112 is not functioning properly but can still communicate with BMU 116, charger 112 can send a signal to the BMU and/or directly to charger 114, indicating that charger 114 should be designated as the primary charger, rather than as the secondary charger. Upon receiving this signal (either from the BMU or directly from charger 112), charger 114 can assume the role of primary charger, and, in some cases, configure its programming to use a “primary node” message set. Charger 114 can then supply the charging load requested by the BMU, without contribution from charger 112.

If the default primary charger (e.g., charger 112 in FIG. 1) is not functioning properly and cannot communicate with the other system components, the BMU can send a signal to another charger in the system (e.g., charger 114 in FIG. 1) designating it as the primary charger. The BMU can determine that the default primary charger is not functioning, for example, if it fails to receive a return signal from the default primary charger after a pre-determined delay subsequent to sending the original signal. In such cases, the backup primary charger (e.g., charger 114 in FIG. 1) can be configured to transmit a confirmation signal to the BMU and/or other chargers in the system. In addition, the backup primary charger can configure its communications system to use a set of commands associated with operating as a primary charger (e.g., a “primary node” message set), rather than a secondary charger (e.g., a “secondary node” message set). The newly designated primary charger can then provide the required charging load (optionally in combination with other functioning chargers in the system), without contribution from the non-functioning default primary charger.

When multiple secondary chargers are used, the system can include a pre-determined hierarchy that can be used to determine which secondary charger is to assume the role of primary charger in case the default primary charger fails. The pre-determined hierarchy can also determine which secondary charger should assume the role of primary charger if both the default primary charger and the backup primary charger fails, and so on. The pre-determined hierarchy can comprise, for example, a list that is pre-programmed within the BMU and/or charger software. In some cases, the pre-determined hierarchy may be based upon a property of the connectors (e.g., an arrangement of port pins) used to connect the chargers to the BMU.

In some embodiments, one or more of the secondary chargers may fail to function properly. For example, a secondary charger might lose its ability to supply power, but still be able to communicate with other components of the system. In such cases, the failed secondary charger might send a signal to the BMU and/or the primary charger (and/or additional secondary chargers) indicating that it cannot supply power. In other cases, a secondary charger might lose its ability to supply power and its ability to communicate with other components of the system. In such cases, the BMU (and/or other components of the system) may determine that the secondary charger is non-functioning if it fails to receive a return signal from the faulty secondary charger after a pre-determined delay subsequent to sending a signal to the faulty charger. In either case, once it has been determined that the secondary charger cannot supply power, the primary charger can reallocate the charging load (e.g., by assuming the entire charging load up to its operational limits, or by allocating the charging load among itself and other secondary chargers) accounting for the failure of the faulty secondary charger. For example, in the set of embodiments illustrated in FIG. 1, if charger 114 loses its ability to supply power to the charging system, charger 112 might assume the entire charging load, up to its operation limits, requested by BMU 116.

The charging systems described herein can be configured to allocate the total charging load in a variety of ways. In some embodiments, the allocation schemes outlined below are executed after the chargers have been assigned primary and secondary charger status via any of the initialization sequences described above. In some embodiments, the BMU can transmit a total charge command to the primary charger. The total charge command can include the requested voltage (V_{command}), the total amount of electrical current requested (I_{command}), and/or the total amount of power requested (P_{command}). The BMU can, in some instances, send a total charge command to each of the chargers in the system. In some such cases, the primary charger can be configured to process the total charge command from the BMU, while the secondary charger(s) can be configured to ignore the total charge command from the BMU.

Upon receiving the total charge command from the BMU, the primary charger can determine how to balance the total requested charging load among itself and/or the secondary charger(s). In some embodiments, if the total power requested by the BMU is equal to or less than the primary charger's output power capability, then only one charger will be activated to supply the requested power. For example, in the set of embodiments illustrated in FIG. 1, if chargers 112 and 114 are each rated to supply 3.3 kW, and the BMU requests a power output of 2 kW, then either charger 112 or charger 114 will be activated to supply the requested power. In some embodiments in which the total power requested is less than the power capabilities of the chargers, the BMU and/or the chargers can be programmed such that each of the chargers provides the requested charging power over discrete, non-overlapping periods of time. For example, in FIG. 1, BMU 116 may be programmed such that charger 112 provides 2 kW of power for a first pre-determined period of time (e.g., 30 minutes). After the first pre-determined period of time, charger 112 can be turned off, and charger 114 can provide 2 kW of power for a second pre-determined period of time (which might be the same as or different from the first pre-determined period of time). The switching of the charging load in this manner can be continued until the battery reaches a desired state of charge.

In some cases, the total time over which charging is to be performed can be calculated from one or more system parameters. For example, the system might be able to detect the state of charge, compare it to a desired state of charge, and calculate the amount of charging time (e.g., for a given charging rate) needed to reach the desired state of charge. The system can be further constructed and arranged to distribute the charging load such that the first and second (or other) chargers are active over substantially equal amounts of time.

If the total power requested by the BMU (P command) command) is greater than the primary charger's output power capability, then multiple chargers (e.g., a pair of chargers in the system, every charger in the system) can be activated to supply the requested power. For example, in the set of embodiments illustrated in FIG. 1, if chargers 112 and 114 are each rated to supply 3.3 kW, and the BMU requests a power output of 5 kW, then both charger 112 and charger 114 will be activated to supply the requested power. In some cases, the total power requested will be distributed evenly among multiple chargers in the system. For example, in FIG. 1, if the BMU requests a power output of 5 kW, each of chargers 112 and 114 can provide 2.5 kW.

In some embodiments in which the total power requested by the BMU (P_{command}) is greater than the primary charger's output power capacity, the primary charger can be placed in a voltage regulation mode, wherein the primary charger voltage is set to the voltage commanded by the BMU (i.e., V_{primary}=V_{command}), and the primary charger current is set to the current requested by the BMU divided by the number of chargers in the system (i.e., I_{primary}=1/n*I_{command}, wherein n is the number of chargers in the charging system). In addition, if the total power requested by the BMU is greater than the primary charger's output power capacity, the secondary charger(s) can be placed in current regulating mode. In current regulating mode, the secondary charger voltage(s) are set slightly higher than the voltage commanded by the BMU (i.e., V_{secondary}=V_{command}+ΔV). In addition, in current regulating mode, the secondary charger current(s) are set to the average of the output currents measured from the primary charger and the secondary charger(s) (i.e.,

$${I}_{secondary} = 1 / n {\sum }_{j = 1}^{n} {I}_{j} ,$$

wherein Iⱼ represents the output current measured from charger j, and n is the number of chargers in the system).

The primary charger can be used to determine the overall charging system status. The primary charger can receive measurements of AC current, AC voltage, HV current, HV voltage, LV voltage, and/or LV current from each of the secondary chargers in the system. The primary charger can average the AC voltage measurements, HV voltage measurements, and/or LV voltage measurements to determine the average AC voltage, average HV voltage, and/or average LV voltage, respectively. In addition, the primary charger can sum the AC current measurements, HV current measurements, and/or LV current measurements to determine the total AC current, total HV current, and/or total LV current, respectively. The primary charger can then transmit any of the average AC voltage, average HV voltage, average LV voltage, total AC current, total HV current, and/or total LV current to the BMU for further processing. In some embodiments, if the default primary charger is unable to supply power, but is still able to communicate with the BMU, the default primary charger can transfer the output power responsibility to a secondary charger but continue to gather and report the total charge system status to the BMU. In some cases, if the default primary charger cannot supply power or communicate with the BMU, another charger in the system can assume the tasks of allocating the charging and reporting the total charge system status to the BMU. In some embodiments, if the total charge system status is being reported by a charger that is not the default primary charger, that charger may include a fault indication signal indicating that the status information is not being sent from the default primary charger.

The charging allocation schemes described above can provide several advantages. For example, identical hardware and software can be used for each charger, even though each charger might behave differently in the system. Because the chargers are configured as primary and secondary chargers based upon a feature of their BMU link, the chargers can be freely interchanged without affecting the primary/secondary assignment scheme. In some cases, all chargers in the system can be identical, thus eliminating installation complexities and confusion. In some cases, each charger can have a unique diagnostic ID, which can allow each charger to be monitored, diagnosed, and/or reprogrammed (e.g., over a CAN bus).

While embodiments featuring a primary charger and a single secondary charger have been illustrated, it should be understood that in some embodiments a third charger, fourth charger, or additional chargers may be used in the charging system. For example, FIG. 1 includes optional third charger 122 that is electrically connected to BMU 116 via link 119, to second charger 114 via link 120, and to first charger 112 via link 121. The third charger can have the same power rating as the first and second chargers, in some embodiments. In some cases, the charging load can be distributed equally among all three chargers. For example, in some embodiments the BMU may receive a request for a power load of 9 kilowatts. The BMU might send a signal to first charger 112 via link 117, and first charger 112 might then send a signal to second charger 114 and/or third charger 122. The second and third chargers may subsequently send a return signal to the first charger indicating their availability to handle a portion of the load. The primary charger may then send a signal to BMU 116 via link 117 including the average AC voltage, average HV voltage, average LV voltage, total AC current, total HV current, and/or total LV current to the BMU for further processing.

Alternatively, in some embodiments, the second and/or third chargers may fail to transmit a signal to the primary charger and/or the BMU, indicating that they are not functioning properly. In such a case, the primary charger may decide to distribute the load only among functioning chargers, or handle the entire load itself, up to its capacity limits. As mentioned above, if the requested load is lower than the rating of each of the chargers, the BMU and/or the first charger can direct the chargers to handle the reduced load shifted over time. For example, in some cases, the first charger may handle the reduced load for a first pre-determined period of time, after which the second charger may handle the reduced load for a second pre-determined period of time, after which the third charger may handle the reduced load for a third pre-determined period of time. By operating in this manner, each of the chargers in the system may exhibit a prolonged operational lifetime relative to systems in which the chargers are constantly handling a charging load.

The BMU and chargers described herein can include any suitable type of controller. In some cases, the processing functions of the BMU and/or chargers can be performed by at least one microprocessor. In addition, the BMU and/or chargers can be programmed using any suitable programming language.

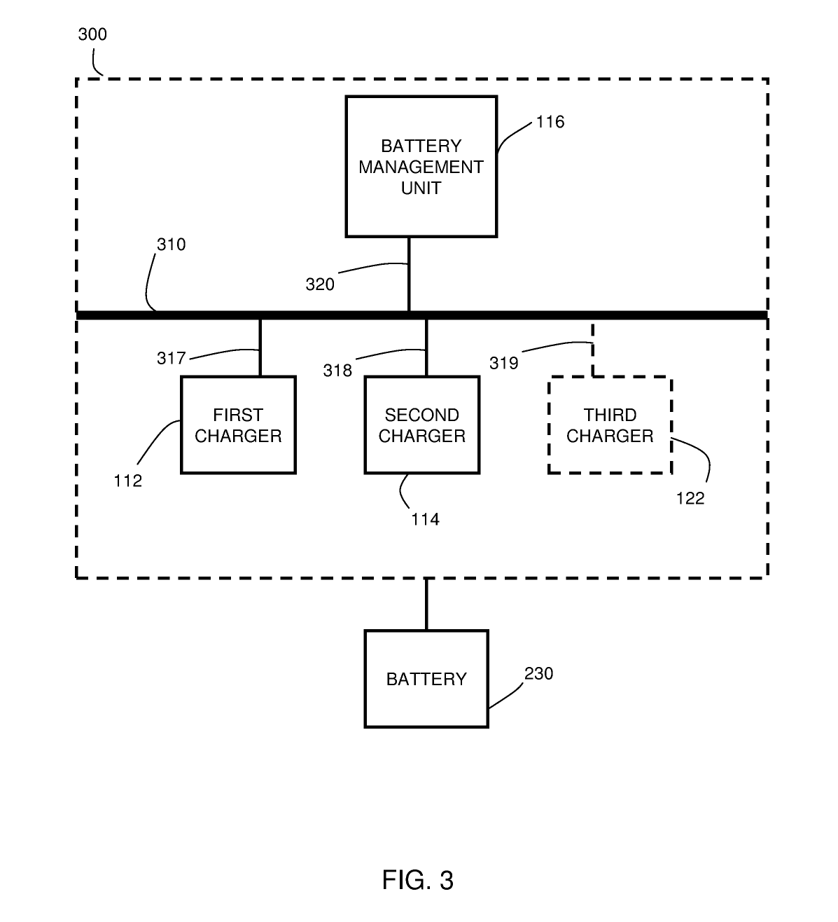

In some cases, data communication and control can be implemented using a standardized protocol. For example, in some embodiments, each of the chargers and/or the BMU can constitute a separate module connected to a controller area network (CAN). In one set of embodiments, the BMU and each of the chargers may constitute separate modules connected to a CAN-bus of an automobile. FIG. 3 includes a schematic illustration of system 300 in which the chargers and BMU communicate via CAN-bus 310. In this set of embodiments, each of charger 112, charger 114, and optional charger 122 are connected to the CAN-bus via cables 317, 318, and 319, respectively. In addition, BMU 116 is connected to the CAN-bus via cable 320. By arranging the chargers and BMU in this way, communication between any of the chargers and/or the BMU can be accomplished via a centralized communication bus.

Any suitable communication link can be used to facilitate communication between two chargers and/or between a charger and the battery management unit. Communication links comprising wires through which data can be transferred are primarily described herein. However, it should be understood that one of ordinary skill in the art would be capable of producing any of the embodiments herein using wireless communication links.

U.S. Provisional Patent Application No. 61/334,337, filed May 13, 2010, and entitled “Battery Charging Using Multiple Chargers” is incorporated herein by reference in its entirety for all purposes.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the described embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the embodiment(s) is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, the embodiments described herein may be practiced otherwise than as specifically described and claimed. The embodiments are directed to each individual feature, system, article, material, and/or method described herein. In addition, any combination of two or more such features, systems, articles, materials, kits, and/or methods, if such features, systems, articles, materials, kits, and/or methods are not mutually inconsistent, is included within the scope of the embodiments described herein.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of charging a battery, comprising:
providing a charging system comprising a first charger, a second charger, and a battery management unit; and
initializing the first and second chargers to determine which of the first and second chargers will subsequently allocate the charging load between the first and second chargers.

2. The method of claim 1, wherein initializing the first and second chargers comprises transmitting a signal from the battery management unit to the first charger, and, based at least in part upon the response of the first charger, determining whether the first charger will subsequently allocate the charging load among the first and second chargers.

3. The method of claim 2, wherein the response of the first charger comprises sending a response signal to the battery management unit indicating that the first charger will subsequently communicate with the battery management unit to determine the allocation of the charging load among the first and second chargers.

4. The method of claim 1, wherein the response of the first charger comprises sending a response signal to the battery management unit indicating that the second charger will subsequently communicate with the battery management unit to determine the allocation of the charging load among the first and second chargers.

5. The method of claim 1, wherein the response of the first charger comprises failing to send a response signal within a pre-determined period of time, thereby indicating that the second charger will subsequently communicate with the battery management unit to determine the allocation of the charging load among the first and second chargers.

6. The method of claim 2, wherein initializing the first and second chargers further comprises transmitting a signal from the battery management unit to the second charger, and, based at least in part upon the response of the second charger, determining whether the second charger will subsequently allocate the charging load among the first and second chargers.

7. The method of claim 1, wherein the charging system further comprises a third charger.

8. The method of claim 7, further comprising initializing the first, second, and third chargers.

9. The method of claim 8, wherein initializing the first, second, and third chargers comprises transmitting a signal from the battery management unit to the third charger, and, based at least in part upon the response of the third charger, determining whether the third charger will subsequently allocate the charging load among the first, second, and third chargers.

10. The method of claim 1, wherein the first and second chargers are constructed and arranged to provide substantially identical amounts of maximum power.

11. A system for charging a battery, comprising:
a first charger; and
a second charger;
wherein at least one of the first and second chargers is constructed and arranged to allocate the charging load between the first and second chargers.

12. A method of charging a battery, comprising:
providing a first charger;
providing a second charger;
charging the battery over a first period of time wherein substantially none of the charging power is provided by the second charger; and
charging the battery over a second period of time wherein substantially none of the charging power is provided by the first charger.

13. A system for charging a battery, comprising:
a first charger; and
a second charger;
wherein the system is constructed and arranged such that the first charger provides the entire system charging power over a first period of time, and the second charger provides the entire system charging power over a second period of time that does not overlap with the first period of time.

14. The system of claim 13, wherein the system is constructed and arranged first and second periods of time are pre-determined.

15. The system of claim 13, wherein the system is constructed and arranged to calculate the amount of time needed to reach a pre-determined charge level and calculate the first and second periods of time based at least in part upon the calculation.

16. The system of claim 13, wherein the first and second period of time are substantially equal.

17. A method of charging a battery, comprising:
providing a charging system comprising a plurality of chargers and a battery management unit wherein each of the plurality of chargers is constructed and arranged to provide power up to a threshold power amount; and
allocating a requested charging power amount among the plurality of chargers,
wherein, if the requested charging power is less than the maximum of the threshold power amounts of the plurality of chargers, one of the plurality of chargers provides the entire amount of requested charging power; and
wherein, if the requested charging power is more than the maximum of the threshold power amounts of the plurality of chargers, the requested charging power is provided by at least two of the plurality of chargers.

18. The method of claim 17, wherein, if the requested charging power is more than the maximum of the threshold power amounts of the plurality of chargers, each of the plurality of chargers provides an amount of power substantially equal to the requested charging power divided by the number of the plurality of chargers.
